(19) United States
(12) Patent Application Publication
(10) Pub. No.: US 2010/0037764 A1
(43) Pub. Date: Feb. 18, 2010

(54) Diaphragm for Pressure-Medium-Actuated Brake Cylinders with Centering Ring

(75) Inventor: Franck HEMERY, Honfleur (FR)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE Systeme fuer Nutzfahrzeuge GmbH, Muenchen (DE)

(21) Appl. No.: 12/544,736

(22) Filed: Aug. 20, 2009

Related U.S. Application Data
(63) Continuation of application No. PCT/EP2008/001403, filed on Feb. 22, 2008.

(30) Foreign Application Priority Data
Feb. 22, 2007 (DE) 10 2007 008 730.8

(51) Int. Cl. F01B 19/00; B60T 17/08

(52) U.S. Cl. 92/99

(57) ABSTRACT

A diaphragm for a pressure-medium-actuated brake cylinder includes a radially outer fastening edge for fixing the diaphragm to the brake cylinder. At least one centering ring, which extends in an axial direction and is offset radially inward in relation to the fastening edge, is formed on the diaphragm. Via the centering ring, the diaphragm can be centered against a radially inner peripheral surface of a wall of the brake cylinder.

### CROSS-REFERENCE TO RELATED APPLICATIONS

This application is a continuation of PCT International Application No. PCT/EP2008/001403, filed Feb. 22, 2008, which claims priority under 35 U.S.C. §119 to German Patent Application No. DE 10 2007 008 730.8, filed Feb. 22, 2007, the entire disclosures of which are herein expressly incorporated by reference.

### BACKGROUND AND SUMMARY OF THE INVENTION

The invention relates to a diaphragm for a pressure-medium-actuated brake cylinder including a radially outer fastening edge for fixing the diaphragm to the brake cylinder, and to a pressure-medium-actuated brake cylinder incorporating the diaphragm.

A diaphragm for a pressure-medium-actuated brake cylinder is known, for example, from DE 40 11 739 A1 and can be loaded by the pressure of a service brake chamber of a service brake cylinder, in order to actuate a service brake. Here, the diaphragm is clamped between the service brake cylinder and an intermediate wall between the service brake cylinder and a spring brake cylinder of a combined service brake and spring brake cylinder by virtue of the fact that the edges of the service brake cylinder and the intermediate wall are bent over to the outside in the manner of a flange and receive a radially outer fastening edge of the diaphragm between them. The walls are clamped against one another by a clamping ring.

However, it can occur during the manufacturing of the diaphragm that the diaphragm is not installed centrally, that is to say coaxially with respect to the center axis of the combined service brake and spring brake cylinder. This has the result that the mechanical stresses in the diaphragm are distributed nonuniformly after the clamping of the clamping ring and, with regard to the high fatigue loading, the diaphragm is pulled out of its clamping point over time or becomes brittle or cracks and undesired leaks are produced as a result.

In contrast, the present invention is based on the object of developing a diaphragm of the above-mentioned type such that it has a higher service life during operation. Furthermore, a pressure-medium-actuated brake cylinder having a diaphragm of this type is to be provided.

According to the invention, a diaphragm is provided for pressure-medium-actuated brake cylinders, including a radially outer fastening edge for fixing the diaphragm to the brake cylinder. At least one centering ring, which extends in the axial direction and is arranged offset radially to the inside in relation to the fastening edge, is formed on the diaphragm, by which centering ring the diaphragm can be centered against a radially inner circumferential face of a wall of the brake cylinder.

Advantageously, incorrect installation of the diaphragm in relation to the brake cylinder in a manner which deviates from a central installation position is no longer possible by virtue of the fact that at least one centering ring, which extends in the axial direction and is arranged offset radially to the inside in relation to the fastening edge, is formed on the diaphragm, by which centering ring the diaphragm can be centered against a radially inner circumferential face of a wall of the brake cylinder. This simplifies and speeds up the manufacture of the brake cylinder. Furthermore, the sealing action of the diaphragm is increased and its service life is extended by the improved centering.

In particular, the centering ring can be configured so as to be completely circumferential as viewed in the circumferential direction or so as to include ring sections, and integrally with the diaphragm.

The radially outer fastening edge of the diaphragm particularly preferably has a wedge-shaped cross-section, which tapers radially toward the inside. If the radially outer fastening edge of the diaphragm is then clamped with the wedge-shaped, radially inwardly tapering cross-section into a receptacle of complementary shape with a wedge-shaped, radially outwardly widening cross-section between a cylinder section and a further cylinder section of the brake cylinder, a clamping force having an axial component of the cylinder sections which are clamped against one another ensures a radially outward directed force onto the diaphragm. As a result, the centering ring of the diaphragm is pressed against the radially inner circumferential face of the wall of the brake cylinder. In other words, the axial component of the clamping force ensures that the fastening edge is pulled radially to the outside on account of the wedge action and, as a result, the centering ring is pressed with a higher radial force against the contact face on the wall of the brake cylinder in the sense of a self-energizing of the centering action. As a result, the security increases against the radially outer fastening edge of the diaphragm being pulled out of the clamped connection.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a cross-sectional illustration of a combined service brake and spring brake cylinder with a diaphragm according to one preferred embodiment of the invention; and

FIG. 2 shows a partially sectioned side view of the service brake cylinder of the combined service brake and spring brake cylinder of FIG. 1 with the diaphragm.

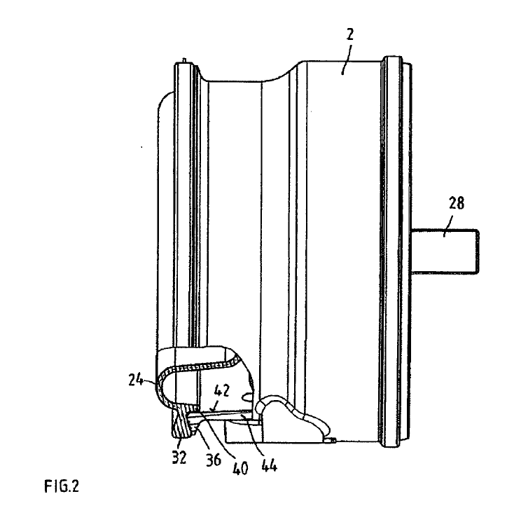

### DETAILED DESCRIPTION OF THE DRAWINGS

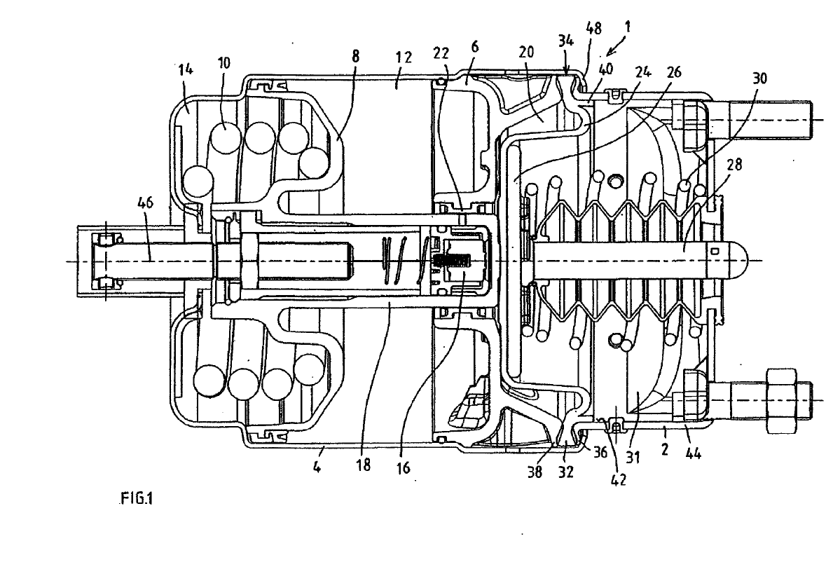

FIG. 1 shows a combined service brake and spring brake cylinder 1, referred to as a combined cylinder in the following text. The combined cylinder 1 includes a service brake cylinder 2 and a spring (stored-energy) brake cylinder 4, which is connected structurally and functionally to the service brake cylinder 2. The service brake cylinder 2 and the spring brake cylinder 4 are divided from one another by an intermediate wall 6. A spring brake piston 8 is arranged displaceably within the spring brake cylinder 4, a storage spring 10 bearing against a side of the spring brake piston 8. On its opposite side, the storage spring 10 is supported on the base of the spring brake cylinder 4. A spring brake chamber 12 is formed between the spring brake piston 8 and the intermediate wall 6, which spring brake chamber 12 is connected to a pressure control module (not shown for reasons of scale), in order to aerate and deaerate it. During aeration, the spring brake piston 8 is displaced axially into the release position of the parking brake under stress of the storage spring 10. During this displacement of the spring brake piston 8, the air within the spring chamber 14 accommodating the storage spring 10 is pressed out via a venting valve 16. If, in contrast, the spring brake chamber 12 is deaearated for the purpose of braking, the storage spring 10 is then capable of displacing the spring brake piston 8 into the brake application position.

The spring brake piston 8 is connected to a hollow piston rod 18, which extends through the intermediate wall 6 into a service brake chamber 20 of the service brake cylinder 2. A seal 22, which is inserted in the intermediate wall 6, seals the outer wall of the piston rod 18 during its longitudinal movement through the intermediate wall 6. An inlet (not shown) opens into the service brake chamber 20, via which inlet compressed air is let in and let out in order to actuate the service brake cylinder 2. The compressed air acts on a diaphragm 24 which is inserted within the service brake cylinder 2 and on the opposite side of which a pressure piece is provided in the form of a rigid diaphragm plate 26. More precisely, the diaphragm 24 separates the service brake chamber 20 of the service brake cylinder 2, which service brake chamber 20 can be loaded with and relieved of pressure medium, from a spring chamber 31 which accommodates a return spring 30 which is supported on the diaphragm plate 26.

The diaphragm plate 26 is connected to a thrust rod 28, which interacts with a brake actuating mechanism outside the combined cylinder 1. Here, the brake actuating mechanism can be, for example, actuating elements of a disk brake of a motor vehicle. The service brake cylinder 2 is an active brake cylinder, that is to say the service brake is applied by aeration of the service brake chamber 20 and is released by deaeration. The return spring 30 which is supported on one side on the diaphragm plate 26 and on the other side on the base of the service brake cylinder 2 ensures that the thrust rod 28 is returned into the release position when the service brake chamber 20 is deaerated.

A radially outer fastening edge 32 of the diaphragm 24 has a wedge-shaped, radially inwardly tapering, cross-section. The radially outer fastening edge 32 of the diaphragm 24 with the wedge-shaped, radially inwardly tapering, cross-section is clamped into a receptacle 34 of complementary shape with a wedge-shaped, radially outwardly widening cross-section between the intermediate wall 6 and the service brake cylinder 2. The intermediate wall 6 and the service brake cylinder 2 form their outer edges as flanges 36, 38, which are bent radially to the outside. The inner faces of the flanges 36, 38, which face one another, form the receptacle 34 with a wedge-shaped cross-section area between them.

Furthermore, at least one centering ring 40, which extends in the axial direction and is arranged offset radially to the inside in relation to the fastening edge 32, is formed on the diaphragm 24. Using the centering ring 40, the diaphragm 24 can be centered against a radially inner circumferential face 42 of a wall 44 of the service brake cylinder 2. The centering ring 40 is arranged particularly preferably substantially perpendicularly with respect to a center plane of the fastening edge 32 and protrudes, for example, away from the diaphragm 24 on one side. However, instead of the one centering ring 40, or in addition, a further centering ring may be provided which protrudes in the direction of the spring brake cylinder 4 and centers its wall against the radially inner circumferential face.

Last but not least, the radially inner circumferential face 42 of the service brake cylinder 2, against which circumferential face 42 the centering ring 40 centers, preferably lies on an imaginary cylinder, the center axis of which is coaxial with respect to the cylinder axis 46.

As shown, the centering ring 40 can be configured so as to be completely circumferential as viewed in the circumferential direction or so as to be comprised of ring sections. The diaphragm 24 is preferably manufactured from rubber and the centering ring 40 is configured integrally with it.

A clamping force having an axial component of the intermediate wall 6 and the service brake cylinder 2, which are clamped against one another, then ensures that the centering ring 40 of the diaphragm 24 is pressed against the radially inner circumferential face 42 of the wall 44 of the service brake cylinder 2. In other words, the axial component of the clamping force ensures that the fastening edge 32 is pulled radially to the outside on account of the wedge action and, as a result, the centering ring 40 is pressed with a higher radial force against the radially inner circumferential face 42 of the wall 44 of the service brake cylinder 2 in the sense of a self-energizing of the centering action.

An axial clamping force component of this type can be realized, for example, by virtue of the fact that the edge of the service brake cylinder 2, which forms a flange 36, and the flange 38 of the intermediate wall 6, are engaged over by an edge 48 of the wall of the spring brake cylinder 4 in the manner of a flange connection which is manufactured, for example, by a forming process. This flange connection then ensures an axial component of the clamping force.

The use of the diaphragm 24 according to the embodiment of the invention with a centering ring 40 is not restricted to a combined service brake and spring brake cylinder 1, but rather it goes without saying that a diaphragm 24 of this type can be used in any type of pressure-medium-actuated brake cylinder.

### TABLE OF REFERENCE SYMBOLS

1 Service brake and spring-force accumulator
2 Service brake cylinder
4 Spring (stored-energy) brake cylinder
6 Intermediate wall
8 Spring brake piston
10 Storage spring
12 Spring brake chamber
14 Spring chamber
16 Venting valve
18 Piston rod
20 Service brake chamber
22 Seal
24 Diaphragm
26 Diaphragm plate
28 Thrust rod
30 Return spring
31 Spring chamber
32 Fastening edge
34 Receptacle
36 Flange
38 Flange
40 Centering ring
42 Radially inner circumferential face
44 Wall
46 Cylinder axis
48 Edge

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component of a pressure-medium-actuated brake cylinder, comprising:
a diaphragm having a radially outer fastening edge which secures the diaphragm to the brake cylinder;
at least one centering ring formed on the diaphragm, the centering ring being arranged radially inward with respect to the fastening edge and extending in an axial direction of the brake cylinder when assembled; and
wherein the centering ring is configured to center the diaphragm with respect to a radially inner circumferential face of a wall of the brake cylinder.

2. The component according to claim 1, wherein the centering ring has a continuous circumferential surface.

3. The component according to claim 1, wherein the centering ring comprises a plurality of ring sections arranged about a circumference.

4. The component according to claim 1, wherein the centering ring is formed integrally with the diaphragm.

5. The component according to claim 1, wherein the radially outer fastening edge of the diaphragm has a wedge-shaped cross-section that tapers radially inward.

6. The component according to claim 1, wherein the centering ring is arranged substantially perpendicularly with respect to a center plane of the fastening edge.

7. The component according to claim 1, wherein the diaphragm is a rubber diaphragm.

8. A pressure-medium-actuated brake cylinder, comprising:
a diaphragm having a radially outer fastening edge which secures the diaphragm to the brake cylinder;
at least one centering ring formed on the diaphragm, the centering ring being arranged radially inward with respect to the fastening edge and extending in an axial direction of the brake cylinder when assembled; and
wherein the centering ring is configured to center the diaphragm with respect to a radially inner circumferential face of a wall of the brake cylinder.

9. The pressure-medium-actuated brake cylinder according to claim 8, wherein the radially inner circumferential face of the wall of the brake cylinder comprises a contact face for contacting an outer circumferential surface of the centering ring of the diaphragm.

10. The pressure-medium-actuated brake cylinder according to claim 9, wherein the contact face lies on an imaginary cylinder, a center axis of which is coaxial with respect to a cylinder axis of the brake cylinder.

11. The pressure-medium-actuated brake cylinder according to claim 8, wherein the radially outer fastening edge of the diaphragm is clamped via a wedge-shaped, radially inwardly tapering cross-section thereof, into a receptacle having a complementary shape with a wedge-shaped, radially outwardly, widening cross-section between a first cylinder section and a second cylinder section of the brake cylinder.

12. The pressure-medium-actuated brake cylinder according to claim 9, wherein the radially outer fastening edge of the diaphragm is clamped via a wedge-shaped, radially inwardly tapering cross-section thereof, into a receptacle having a complementary shape with a wedge-shaped, radially outwardly, widening cross-section between a first cylinder section and a second cylinder section of the brake cylinder.

13. The pressure-medium-actuated brake cylinder according to claim 10, wherein the radially outer fastening edge of the diaphragm is clamped via a wedge-shaped, radially inwardly tapering cross-section thereof, into a receptacle having a complementary shape with a wedge-shaped, radially outwardly, widening cross-section between a first cylinder section and a second cylinder section of the brake cylinder.

14. The pressure-medium-actuated brake cylinder according to claim 8, wherein the brake cylinder comprises a service brake cylinder, a spring brake cylinder, and an intermediate wall arranged between the service brake cylinder and the spring brake cylinder.

15. The pressure-medium-actuated brake cylinder according to claim 14, wherein the diaphragm separates a service brake chamber of the service brake cylinder, which service brake chamber is aerated and deaerated with a pressure medium, from a spring chamber of the service brake cylinder, which spring chamber accommodates a return spring.

16. The pressure-medium-actuated brake cylinder according to claim 15, wherein the diaphragm interacts with a rigid diaphragm plate connected to a thrust rod of the service brake cylinder.
